(19) United States
(12) Patent Application Publication
(10) Pub. No.: US 2025/0237588 A1
(43) Pub. Date: Jul. 24, 2025

(54) INDENTATION PLASTOMETY

(71) Applicant: PLASTOMETREX LTD, Cambridge Cambridgeshire (GB)

(72) Inventors: Trevor William CLYNE, Cambridge Cambridgeshire (GB); James DEAN, Cambridge Cambridgeshire (GB); James Edward CAMPBELL, Cambridge Cambridgeshire (GB); Max Edward BURLEY, Cambridge Cambridgeshire (GB); Wenchen GU, Cambridge Cambridgeshire (GB); Rebecca REIFF-MUSGROVE, Cambridge Cambridgeshire (GB)

(21) Appl. No.: 18/834,835

(22) PCT Filed: Feb. 2, 2023
(86) PCT No.: PCT/EP2023/052588

§ 371 Date: Jul. 31, 2024

(30) Foreign Application Priority Data
Feb. 3, 2022 (GB) 2201411.2

(51) Int. Cl. G01N 3/44

(52) U.S. Cl. CPC G01N 3/44; G01N 2203/0075; G01N 2203/008; G01N 2203/0208; G01N 2203/0216

(57) ABSTRACT

A method of performing indentation plastometry is provided. The method includes steps of: providing a sample of a material and an indenter having a contact surface of a predetermined shape and size; forming a first indent having a first penetration depth within the sample by applying a load to press the contact surface of the indenter into the sample; measuring a first indent profile of the first indent; on the basis of the first indent profile, and the applied load to form the first indent, obtaining a preliminary measurement of a characteristic of the material; on the basis of the obtained preliminary measurement of the characteristic of the material, determining whether a second indent having a different, second penetration depth is required to obtain a more accurate measurement of the characteristic of the material, and when the second indent is required, determining a value for the second penetration depth; forming the second indent having the second penetration depth within the sample by applying a load to press the contact surface of the indenter into the sample; measuring a second indent profile of the second indent; and on the basis of the second indent profile, the applied load to form the second indent, obtaining the more accurate measurement of the characteristic of the material.

This application claims priority from GB 2201411.2 filed 3 Feb. 2022, the contents and elements of which are herein incorporated by reference for all purposes.

### FIELD OF THE INVENTION

The present invention relates to indentation plastometry.

### BACKGROUND

Inelastic mechanical properties materials are conventionally obtained via uniaxial (tensile or compressive) tests. However, use of an indentation-based technique brings important advantages. These include a reduction in the size and shape requirements for the sample. Commonly, only a (small) flat plate is used. Also, the fact that properties are being measured in a relatively small region allows local variations in properties to be examined over the surface of a component.

More particularly, indentation plastometry generally involves penetrating an indenter into a sample of the material, removing the indenter, measuring the residual indent profile, and then performing iterative numerical modelling of the indentation process. The indenters are typically made of a material much harder than the sample, so as to prevent plastic deformation of the indenter, and usually have a convex surface for engaging with the sample. The convex surface causes the size and shape of the (concave) indentation to correspond to the depth of penetration. A typical type of indenter used in indentation plastometry has a spherical surface and is made of a ceramic or cermet material.

“Hardness” by contrast is a commonly-used material property measured in a traditional hardness test, with hardness values of a material typically being obtained by measuring just the lateral dimensions of a residual indent created by the application of a given load for a short period of time. Hardness is related to the yield stress and work hardening characteristics of the material but is not a well-defined property. For instance, a variety of hardness values are obtained using different indenter shapes and applied loads. As such, characteristics of materials such as yield stress and work hardening behaviour cannot be determined from traditional hardness tests.

In order to determine such characteristics, indentation plastometry, as mentioned above, generally involves iterative numerical modelling of the indentation process, using a Finite Element Method (FEM) for example, with the plastic deformation of the material being captured in the form of a constitutive law containing adjustable parameters, and repeated comparisons being made between experimental and modelled outcomes. In this way, software packages can be devised that allow automated extraction of best fit plasticity parameter values via processing of experimental indentation data. A similar methodology can be used to obtain information about residual stresses in samples. A number of papers [1-9] have been published regarding various details of such methodologies. Several of these have highlighted the advantages of using the indent profile (rather than conventional load-displacement curves). The performance of indentation, profilometry and iterative numerical modelling procedure is termed PIP (Profilometry-based Inverse FEM Indentation Plastometry).

However, current indentation plastometry techniques can involve a source of error which may limit the accuracy of their results. This source of error is caused by the different stress-strain curves, and in particular, the different work hardening rates (i.e. the rate at which stress rises as plastic straining takes place), associated with different materials. That is, in some materials, stress rises more quickly with plastic straining compared to others, such materials exhibiting higher work hardening rates. The magnitude of the plastic strain created during indentation plastometry is related to the penetration depth of the indenter into the sample. The penetration depth is therefore an important parameter. If it is very shallow, then the plastic strains induced in the sample will be low, which can lead to poor accuracy in the inferred stress-strain curve, particularly at relatively high strains. Conversely, there is a maximum penetration depth, dictated by the load capacity of the system and the hardness of the sample. There is also an optimum penetration depth which produces the most accurate stress-strain curve, and, in most cases, the optimum penetration depth is lower than the maximum penetration depth. The optimum penetration depth can vary between samples, depending on the nature of their stress-strain curves, and in particular on their work hardening rates.

A number of papers [3, 10-17] have proposed forming multiple indents in the sample, usually having different penetration depths, shapes, and/or sizes, to generate a wider range of input data which can be used to reduce the error on the measurement result (e.g. a stress-strain curve). However, forming many different indents and aggregating their properties to error-correct an inferred measurement can be time-consuming and inefficient.

Therefore, it is desirable to provide a method of performing indentation plastometry which has an improved accuracy, reliability, and time-efficiency.

The present invention has been devised in light of the above considerations.

### SUMMARY OF THE INVENTION

The present invention is at least partly based on a realisation that, rather than forming many different indents and aggregating their properties to error-correct an inferred measurement, it is possible to perform a multi-stage intelligent indentation plastometry method which uses a preliminary indent profile measurement obtained during an initial indentation process to determine in real time whether a further indentation process is required, and if so, what characteristics it should have, in order to obtain a more accurate measurement of the sample's inelastic mechanical properties.

Accordingly, in a first aspect, the present invention provides a method of performing indentation plastometry, the method including the steps of:
providing a sample of a material and an indenter having a contact surface of a predetermined shape and size;
forming a first indent having a first penetration depth within the sample by applying a load to press the contact surface of the indenter into the sample;
measuring a first indent profile of the first indent;
on the basis of the first indent profile, and the applied load to form the first indent, obtaining a preliminary measurement of a characteristic of the material;
on the basis of the obtained preliminary measurement of the characteristic of the material, determining whether a second indent having a different, second penetration depth is required to obtain a more accurate measurement of the characteristic of the material, and when the second indent is required, determining a value for the second penetration depth;
forming the second indent having the second penetration depth within the sample by applying a load to press the contact surface of the indenter into the sample;
measuring a second indent profile of the second indent; and
on the basis of the second indent profile, the applied load to form the second indent, obtaining the more accurate measurement of the characteristic of the material.

Thus the preliminary measurement from the first indentation process is used to inform whether the second indent should be performed and to what penetration depth. This two stage, linked approach advantageously avoids the need to perform multiple independent indents with subsequent aggregation of properties. Indeed, the method allows that the second indent is only formed when it is required to improve the accuracy of the measurement, e.g. when the sample is found from the preliminary measurement to have a high work hardening rate. Furthermore, the determination of whether the second indent is required can be made in real time. Thus, the time-efficiency to arrive at the more accurate measurement can be increased. In addition, when it is determined that a second indent is required, a value for the second penetration depth can preferably be determined based on the obtained preliminary measurement of the characteristic. Advantageously, this can ensure that the second penetration depth is optimised for obtaining the more accurate measurement.

The second penetration depth may be greater than the first penetration depth. This is typical, for example, when the preliminary measurement indicates a relatively high work hardening rate for the material. Indeed, conveniently the second indent can be superimposed on the first indent. That is, the second indent can be formed directly on and thereby supersede the first indent. Since load removal involves little or no inelastic deformation within the sample, forming the second indent in this manner generally does not compromise the accuracy of the final measurement and advantageously, it can increase the time-efficiency of the method, as there is no need to change the relative positions of the indenter and the sample.

The contact surface of the indenter may lie on a sphere having a radius, R. For example, the indenter may simply be a sphere. This spherical contact surface is particularly helpful when performing PIP analysis to obtain the preliminary and more accurate measurements of the characteristic of the material. This is because the inverse FEM modelling, which is part of the PIP procedure, can be carried out with the indenter assumed still to be a sphere (that remains elastic during the test) albeit with adjustment made for the change in its shape.

The first penetration depth may be about 10% of R. Such a value corresponds to a relatively shallow first indent and can therefore be used to effectively probe the material to gauge whether the second indent is required.

The second penetration depth may be in the range from 15% to 20% of R. Advantageously, such greater penetration depths are typically suitable for obtaining the more accurate measurement of the characteristic for materials shown to have higher work hardening rates.

The steps of obtaining the preliminary and more accurate measurements of the characteristic of the material may be performed by numerically modelling the penetration of the indenter into the sample. For example, the numerical modelling may be based on a finite element model as used e.g. in PIP analysis.

The preliminary and more accurate measurements of the characteristic of the material may be obtained on the basis of respective elastic constants of the indenter material and the sample material, as well as on the indent profiles, and the applied loads. That is, the elastic constants of the sample material and the indenter material are typically known in advance and used e.g. as inputs to the numerical modelling, rather than, particularly in the case of the sample material, being obtained from such modelling. On the other hand, plastic deformations of the material are usually a product of many different factors and therefore it can be advantageous to capture them in the form of a constitutive law containing adjustable parameters, and to repeatedly compare between experimental and modelled outcomes to accurately infer inelastic mechanical properties of the material. In this way, software packages can be devised that allow automated extraction of best fit plasticity parameter values via processing of experimental indentation data, which can improve the reliability and time-efficiency of the indentation plastometry method.

The characteristic of the material may be a stress-strain curve, preferably a true stress-true strain curve, such curves generally exhibiting regions of plastic deformation which are indicative of inelastic mechanical properties of materials.

The preliminary measurement of the characteristic of the material may provide an indication of a work hardening rate of the material, and the determination that the second indent is required may be made when the work hardening rate exceeds a predetermined level. Advantageously, a work hardening rate above a certain level can usefully indicate when a second indent will be beneficial, and can also indicate a suitable magnitude for the second penetration depth to yield the more accurate measurement of the characteristic of the material.

In a second aspect, the present invention provides an apparatus for performing indentation plastometry, the apparatus including:
an indenter having a contact surface of a predetermined shape and size;
a testing machine configured to: apply a load to press the contact surface of the indenter into a sample of a material to form a first indent therein, the first indent having a first penetration depth, and measure a first indent profile of the first indent; and
a computer programmed to:
   obtain a preliminary measurement of a characteristic of the material on the basis of: the first indent profile, and the applied load to form the first indent; and
   based on the obtained preliminary measurement of the characteristic, determine whether a second indent having a different, second penetration depth is required to obtain a more accurate measurement of the characteristic of the material, and when the second indent is required, determine a value for the second penetration depth;
wherein:
   the testing machine is further configured to: apply a load to press the contact surface of the indenter into the sample to form the second indent therein, the second indent having the second penetration depth, and measure a second indent profile of the second indent; and
   the computer is further programmed to: obtain the more accurate measurement of the characteristic of the material on the basis of the second indent profile, and the applied load to form the second indent.

Accordingly, the apparatus is suitable for performing the method of the first aspect.

In a third aspect, the present invention provides a computer program comprising code which, when the code is executed on a computer:
obtains a preliminary measurement of a characteristic of a material on the basis of results of a first indentation plastometry test in which: a first indent having a first penetration depth is formed within a sample of a material by applying a load to press a contact surface of an indenter into the sample, the contact surface having a predetermined shape and size, and the results of the first indentation plastometry test being the applied load to form the first indent, and a measured profile of the first indent;
on the basis of the obtained preliminary measurement of the characteristic of the material, determines whether a second indent having a different, second penetration depth is required to obtain a more accurate measurement of the characteristic of the material, and when the second indent is required, determines a value for the second penetration depth;
obtains the more accurate measurement of the characteristic of a material on the basis of results of a second indentation plastometry test in which: a second indent having the second penetration depth is formed within the sample of a material by applying a load to press the contact surface of an indenter into the sample, the results of the second indentation plastometry test being the applied load to form the second indent, and a measured profile of the second indent.

Accordingly, the computer program is suitable for performing the method of the first aspect.

In a fourth aspect, the present invention provides a computer readable medium storing the computer program according to the third aspect.

In a fifth aspect, the present invention provides a computer programmed to execute the computer program according to the third aspect.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 shows schematically a loading arrangement for performing indentation plastometry;

FIG. 2 shows nominal stress-strain plots from tensile testing of an as-received Cu sample and an annealed Cu sample, up to rupture;

FIG. 3A shows a modelled plastic strain field in the as-received Cu sample of FIG. 2, and FIG. 3B shows the equivalent modelled plastic strain field in the annealed Cu sample of FIG. 2;

FIG. 4 shows fractions of the total work done in different ranges of strain during indenter penetration of annealed Cu to three different penetration depths;

FIG. 5 shows average plastic strains, for several materials, as a function of penetration ratio;

FIG. 6 is a block diagram showing the steps of an improved method of performing indentation plastometry;

FIG. 7 shows PIP-determined YS and UTS as a function of different penetration ratios for a material exhibiting a relatively high work hardening rate, and also corresponding values for YS and UTS derived from tensile testing; and

FIG. 8 shows PIP-determined YS and UTS as a function of different penetration ratios for a material exhibiting a lower work hardening rate than the material of FIG. 7 and also corresponding values for YS and UTS derived from tensile testing.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

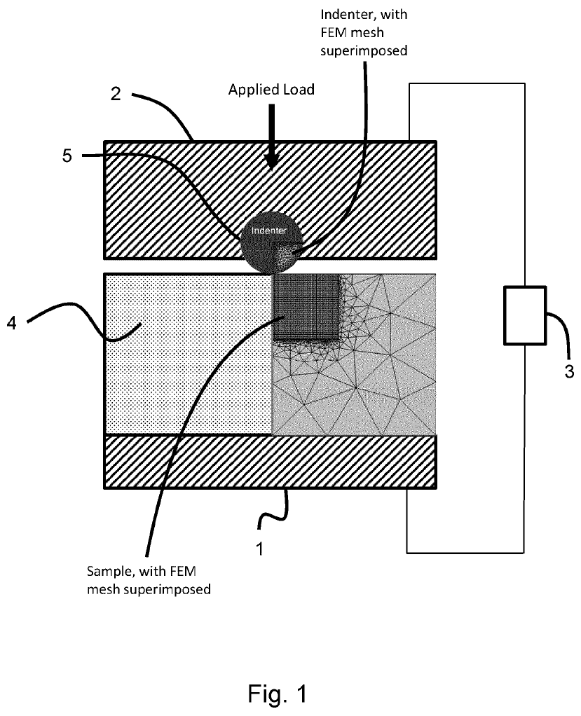

FIG. 1 shows schematically a loading arrangement for performing indentation plastometry. The arrangement includes a testing machine operating upon a sample base 1 and an indenter housing 2. The testing machine is configured to move the indenter housing 2 towards and away from the sample base 1, such that the relative displacement between the sample base 1 and the indenter housing 2 along the loading axis changes. This relative displacement is measurable by a displacement measurement system 3 connected to the indenter housing 2 and the sample base 1. The displacement measurement system may comprise a linear variable displacement transducer (LVDT) or another device for measuring displacement.

Sandwiched between the sample base 1 and the indenter housing 2, are a test sample 4 and an indenter 5. The sample 4 is mounted onto the sample base 1 so as to be fixed relative thereto, and the indenter 5 is held by the indenter housing 2. The indenter in this example has a spherical shape and a radius, R.

The indenter 5 is typically made of a ceramic or cermet material. This ensures that the indenter does not deform plastically during performance of indentation plastometry. In general, the indenter 5 is made of a material that is significantly harder than the sample material under the conditions of the plastometry testing. The sample 4 is significantly larger than the indenter 5. The contact surface is that part of the indenter 5 which contacts the sample 4 when the indenter 5 and the sample 4 are brought together.

When performing the indentation plastometry, the testing machine offers the indenter 5 to the sample 4 such that a contact surface of the indenter 5 rests on the sample 4. The testing machine then applies a load to the indenter 5, to press the indenter 5 into the sample 4, forming an indentation in the sample matching the shape of the contact surface. The surface of the sample 4 contacted by the indenter 5 is typically flat and perpendicular to the direction of the applied load.

As the applied load causes the indenter 5 to progressively penetrate into the sample 4, the displacement measurement system 3 may measure and record the relative positions of the indenter housing 2 and the sample base 1, which corresponds to the depth of penetration into the sample 4 by the indenter 5. The load can be continuously monitored, for example via a load cell incorporated in a loading train of the testing machine. The contact surface has a known shape and size. The shape and size of the corresponding indentation are directly measured, typically by profilometry, after release of the load.

After the indenting and profilometry are completed, PIP analysis is performed. More particularly, FEM meshes superimposed onto the sample 4 and the indenter 5 are used to numerically model the penetration of the indenter 5 into the sample 4 by a computer using the known shapes and sizes of the contact surface and the indentation, and a constitutive law. Separately, the elastic properties of the indenter and the sample are also generally required for the modelling.

Measures may be taken to ensure that the indenter does not plastically deform during indentation, for example by ensuring that the ratio of the yield stress of the indenter to that of the sample is greater than about two.

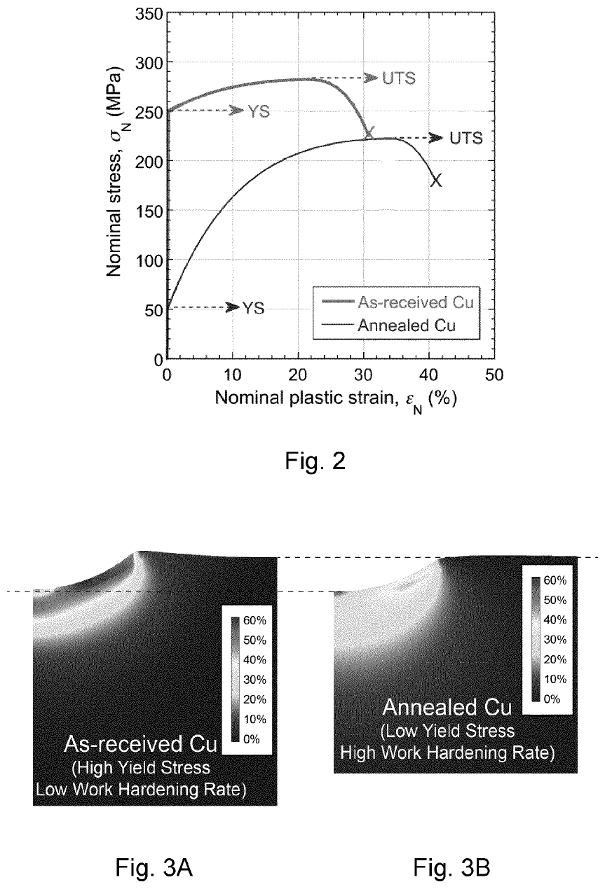

Before discussing how such numerical modelling can measure useful characteristics of the material in a two stage indentation procedure, it is helpful to consider, with reference to FIGS. 2 to 5, features of inelastic materials behaviour, such as work hardening rates.

FIG. 2 shows nominal stress-strain plots from tensile testing of an as-received Cu sample and an annealed Cu sample, up to rupture. Typically, the values of interest in (nominal) stress-strain curves of this type are those of the yield stress (YS) and the ultimate tensile strength (UTS). The UTS normally corresponds to the onset of neck formation. As illustrated by FIG. 2, materials having a high work hardening rate (i.e. the rate at which the stress rises as plastic straining takes place), such as annealed Cu, tend to exhibit a larger difference between the UTS and the YS relative to materials having a lower work hardening rate, such as the as-received Cu.

Materials having different work hardening rates, and thus different stress-strain curves, also exhibit different plastic strain fields for a given penetration depth. This can be seen in FIGS. 3A and 3B. FIG. 3A shows a modelled plastic strain field in the as-received Cu sample of FIG. 2, and FIG. 3B shows the corresponding modelled plastic strain field in the annealed Cu sample of FIG. 2. In both examples, the penetration depth, δ, is 20% of R (the radius of the indenter), i.e. δ/R=20%. δ/R is known as a penetration ratio. In the case of the as-received Cu having a lower work hardening rate, the plastic strains are concentrated and a high “pile-up” forms around the “crater” of the indent. In contrast, the plastic strain field in the case of annealed Cu, having a higher work hardening rate, is more “diffused” into the interior of the sample, with lower peak strains. Since there is an incentive to cover a particular strain range (typically up to values of at least several tens of percent) in order to more completely explore a material's plastic response in an indentation test, it is preferable to penetrate more deeply into materials that exhibit more pronounced work hardening in order to obtain more accurate measurements of their corresponding strain-stress curves.

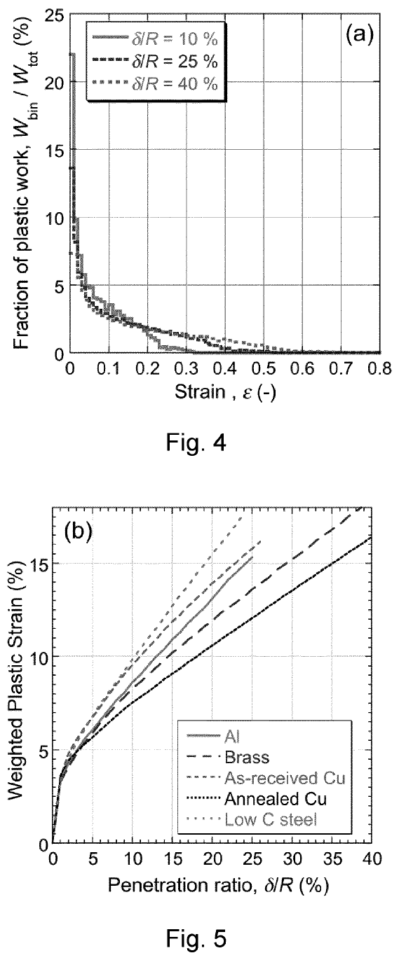

However, the nature of the plastic straining within a sample, and its effect on the outcome of the indentation test, cannot be fully captured solely by identifying the peak strain level. For example, if this level had been created only in a very small volume, then the influence on the overall outcome of that part of the stress-strain curve would be very limited. A more reliable indicator of the nature of the plastic straining within the sample is how much of the deformation that affects the indentation response takes place in different ranges of strain. The final indent profile will be more sensitive to parts of the stress-strain curve within which larger amounts of plastic deformation took place during indentation. Outcomes of analyses of this type are presented in FIG. 4 showing fractions of the plastic work done, W_{bin}/Wₜₒₜ, as a function of the strain, &, at which it took place, in the annealed Cu sample of FIG. 2, for 3 different δ/R ratios. Additionally, FIG. 5 is a plot of the average strain at which the plastic work was done, for several metals, as a function of δ/R. The average strains tend to be lower, at a given δ/R, for metals that exhibit a greater work hardening rate. The curve for the annealed Cu is thus appreciably below that for the as-received Cu. Consequently, for materials having different work hardening rates, different penetration ratios are required to achieve the same plastic strain. If, for example, the target level for the weighted plastic strain were 10%, then the target penetration ratio (δ/R) would be about 10% (i.e. δ=100 μm when R=1 mm) for the as-received Cu, but about 18% for the annealed Cu.

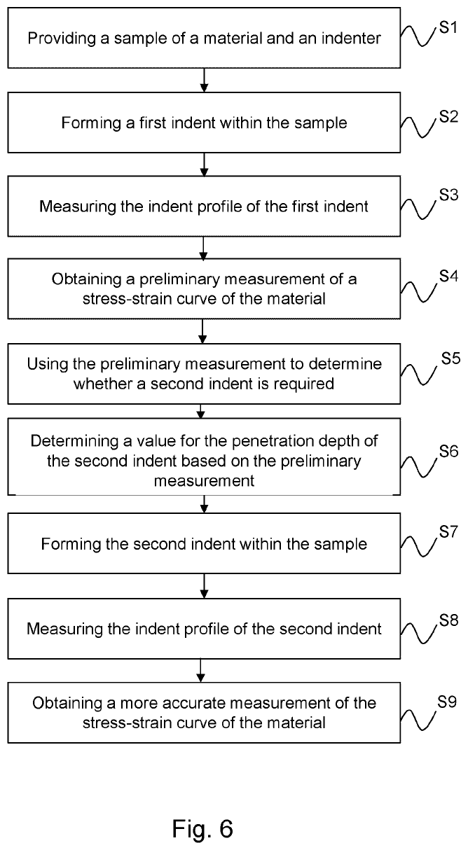

In appreciation of the above discussion of materials' plastic straining behaviour, an improved method of accurately performing intelligent indentation plastometry in a time-efficient manner is described below. FIG. 6 is a block diagram showing steps of the method. At S1, a sample of a material is provided together with an indenter having a contact surface of a predetermined shape and size. Using the loading arrangement of FIG. 1, at S2, a first indent is formed within the sample. The first indent has a first penetration depth, δ, which is preferably chosen to be relatively shallow, i.e. around 10% of R. Advantageously, such relatively shallow first penetration depth is suitable for “probing” the material's plastic strain behaviour.

At S3, a first indent profile of the first indent is measured. The relationship between the measured indent profile and an inferred true stress-strain relationship is a complex one. The factors that affect it include the precision of the measurements, details of the finite element modelling and convergence algorithm, the possibility of anisotropy and/or inhomogeneity in the sample and the scale of the deformed volume, as well as the penetration ratio (and thus, the penetration depth). Therefore, at S4, the measured first indent profile is used, together with the applied load used to create the first indent, and with parameters describing the elastic properties of the indenter and the sample, to obtain an adequate preliminary measurement of a true stress-true strain curve of the material. Advantageously, the stress-strain curve provides an indication of a work hardening rate of the material which, as discussed in FIGS. 2 to 5, is central to the plastic straining behaviour of the sample. The process used to obtain the preliminary measurement involves performing numerical modelling of the penetration of the indenter into the sample, e.g. PIP analysis, as described in relation to FIG. 1. The obtained preliminary measurement of the stress-strain curve can provide an indication of the work hardening rate of the material.

At S5, the obtained preliminary measurement is used to determine whether a second indent having a different, second penetration depth is required to obtain a more accurate measurement of the stress-strain curve of the material. Advantageously, this can ensure that further indents are only formed within the sample when they are required to improve the accuracy of the measurement, e.g. when the sample has a high work hardening rate. Furthermore, the determination of whether a further indent is required can be made in real time. In particular, the determination can be made at least partially on the basis of whether the preliminary measurement of the work hardening rate exceeds a predetermined level. This is consistent with the discussion of, for example, FIG. 5, which established that materials exhibiting higher work hardening rates require indents having larger penetration depth ratios to produce a desired amount of plastic strain.

Provided that a second indent is required, the method proceeds to S6 and based on the preliminary measurement, determines a value for the second penetration depth suitable for producing a more accurate measurement of the true stress-true strain curve. Typically, the second penetration depth is chosen to be larger than the first penetration depth. Preferably, the second penetration depth is from 15% to 20% of R. Additionally or alternatively, the second penetration depth can be chosen based on the obtained work hardening rate using a predetermined setting/database. For example, the work hardening rate from the preliminary measurement can be used in an analytical expression, along with e.g. the absolute value of the yield stress from the preliminary measurement to give a penetration depth for the second indent. The analytical expression can be empirically derived. An advantage of using such an expression is that it can be evaluated very quickly, allowing the method to be performed in real time.

At S7, the second indent having the second penetration depth is formed in the sample in the same manner as the first indent. The second indent can be superimposed on the first indent such that it supersedes it, i.e. by having a larger penetration depth. This can increase the time-efficiency of the method, as there is no need to change the relative positions of the indenter and the sample

Next, a second indent profile of the second indent is measured at S8. Finally, at S9, the measured second profile, the applied load to form the second indent, and the parameters describing the elastic properties of the indenter and the sample, are used to obtain the more accurate measurement of the stress-strain curve of the material.

Advantageously, since the time required to carry out the PIP analysis at S4 is short, as is the determination at S5, the total time needed to perform the method is estimated to be relatively short: around 5 minutes to complete all of steps S1 to S9, compared to 3 minutes for a single indent and PIP analysis (corresponding to steps S1 to S4). Conveniently, the method can be fully automated between steps S2 and S9.

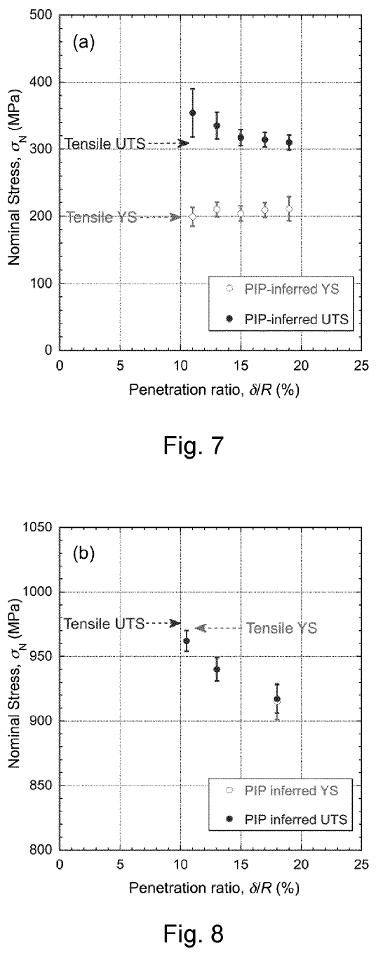

The improved accuracy of the strain-stress relationship obtained by performing the method is illustrated by the plots of FIGS. 7 and 8 showing PIP-determined values for YS and UTS as a function of different penetration ratios for two materials exhibiting different work hardening rates. In particular, the work hardening rate of the material of FIG. 7 is higher than that of the material of FIG. 8. Also shown on each plot are values (indicated by arrows) for the YS and UTS of the respective material obtained by tensile testing. These tensile testing values for YS and UTS are the “gold standard” which the PIP-determined values should ideally replicate. Although a true stress-true strain curve was used in the PIP modelling, i.e. in the constitutive law used to describe the material. The data of FIGS. 7 and 8 are based on nominal stress-nominal strain curves, the concept of a UTS being inherently associated with a nominal stress-nominal strain plot for tensile testing.

In FIG. 7, increasing the penetration ratio for a material exhibiting a high work hardening rate, results in improved accuracy and precision of the PIP-determined stress-strain curve. In particular a significant improvement is seen in the accuracy of the UTS measurement. Thus, implementing the method of FIG. 6, where a second indent having a larger penetration depth is formed into the sample of the material exhibiting a high work hardening rate, should result in improved accuracy and precision of the PIP-inferred stress-strain curve.

In contrast, in FIG. 8, increasing the penetration ratio for a material exhibiting a low work hardening rate, results reduced accuracy and precision of the PIP-determined stress-strain curve (both YS and UTS). However, the method of FIG. 6, by providing a preliminary indication of low work hardening rate, can inform a decision not to proceed to a larger penetration depth, or indeed to suggest a second indentation at a lower depth.

Modifications to the method of FIG. 6 are possible. For example, step S6 may be repeated after S9, but with the more accurate measurement in place of the preliminary measurement, to determine whether further indents are required to obtain an even more accurate measurement of the characteristic of the material. Thus, more than two indents can be formed as part of the indentation plastometry method.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

### REFERENCES

A number of publications are cited above in order to more fully describe and disclose the invention and the state of the art to which the invention pertains. Full citations for these references are provided below. The entirety of each of these references is incorporated herein.
1. J Dean, J M Wheeler & T W Clyne, Use of Quasi-Static Nanoindentation Data to Obtain Stress-Strain Characteristics for Metallic Materials, Acta Materialia, 58 (2010) p. 3613-23.
2. D K Patel & S R Kalidindi, Correlation of spherical nanoindentation stress-strain curves to simple compression stress-strain curves for elastic-plastic isotropic materials using finite element models, Acta Materialia, 112 (2016) p. 295-302.
3. J Dean & T W Clyne, Extraction of Plasticity Parameters from a Single Test using a Spherical Indenter and FEM Modelling, Mechanics of Materials, 105 (2017) p. 112-22.
4. J E Campbell, R P Thompson, J Dean & T W Clyne, Experimental and Computational Issues for Automated Extraction of Plasticity Parameters from Spherical Indentation, Mechanics of Materials, 124 (2018) p. 118-31.
5. J E Campbell, R P Thompson, J Dean & T W Clyne, Comparison between stress-strain plots obtained from indentation plastometry, based on residual indent profiles, and from uniaxial testing, Acta Materialia, 168 (2019) p. 87-99.
6. M Burley, J E Campbell, R Reiff-Musgrove, J Dean & T W Clyne, The Effect of Residual Stresses on Stress-Strain Curves Obtained via Profilometry-Based Inverse Finite Element Method Indentation Plastometry, Adv. Eng. Mats., 23 (2021) p. 2001478.
7. Y T Tang, J E Campbell, M Burley, J Dean, R C Reed & T W Clyne, Use of Profilometry-based Indentation Plastometry to obtain Stress-Strain Curves from Small Superalloy Components made by Additive Manufacturing, Materialia, 15 (2021) p. 101017.
8. J E Campbell, H Zhang, M Burley, M Gee, A T Fry, J Dean & T W Clyne, A Critical Appraisal of the Instrumented Indentation Technique (IIT) and Profilometry-based Inverse FEM Indentation Plastometry (PIP) for Obtaining Stress-Strain Curves, Adv. Eng. Mats., 23 (2021) p. 2001496.
9. T W Clyne, J E Campbell, M Burley & J Dean, Profilometry-based Inverse FEM Indentation Plastometry (PIP), Adv. Eng. Mats., (2021) p. 21004037.
10. N Chollacoop, M Dao & S Suresh, Depth-sensing instrumented indentation with dual sharp indenters, Acta Materialia, 51 (2003) p. 3713-29.
11. S Bhagavat & I Kao, Ultra-low load multiple indentation response of materials: In purview of wiresaw slicing and other free abrasive machining (FAM) processes, International Journal of Machine Tools & Manufacture, 47 (2007) p. 666-72.
12. C Heinrich, A M Waas & A S Wineman, Determination of material properties using nanoindentation and multiple indenter tips, Int. J. Solids and Structures, 46 (2009) p. 364-76.
13. C Feng, J M Tannenbaum, B S Kang & M A Alvin, A Load-Based Multiple-Partial Unloading Micro-Indentation Technique for Mechanical Property Evaluation, Experimental Mechanics, 50 (2010) p. 737-43.
14. L Meng, P Breitkopf, B Raghavan, G Mauvoisin, O Bartier & X Hernot, Identification of material properties using indentation test and shape manifold learning approach, Computer Methods in Applied Mechanics and Engineering, 297 (2015) p. 239-57.
15. A S Shedbale, I V Singh, B K Mishra & K Sharma, Evaluation of mechanical properties using spherical ball indentation and coupled finite element-element-free galerkin approach, Mechanics of Advanced Materials and Structures, 23 (2016) p. 832-43.
16. S Hamada, S Kashiwa & H Noguchi, Measurement of local mechanical properties using multiple indentations by a special conical indenter and error analysis, Journal of Materials Research, 31 (2016) p. 259-73.
17. J Wei, B L McFarlin & A J W Johnson, A multi-indent approach to detect the surface of soft materials during nanoindentation, Journal of Materials Research, 31 (2016) p. 2672-85.

1. A method of performing indentation plastometry, the method including the steps of:
providing a sample of a material and an indenter having a contact surface of a predetermined shape and size;
forming a first indent having a first penetration depth within the sample by applying a load to press the contact surface of the indenter into the sample;
measuring a first indent profile of the first indent;
on the basis of the first indent profile, and the applied load to form the first indent, obtaining a preliminary measurement of a characteristic of the material;
on the basis of the obtained preliminary measurement of the characteristic of the material, determining whether a second indent having a different, second penetration depth is required to obtain a more accurate measurement of the characteristic of the material, and when the second indent is required, determining a value for the second penetration depth;
forming the second indent having the second penetration depth within the sample by applying a load to press the contact surface of the indenter into the sample;
measuring a second indent profile of the second indent; and
on the basis of the second indent profile, the applied load to form the second indent, obtaining the more accurate measurement of the characteristic of the material.

2. The method according to claim 1, wherein the second penetration depth is greater than the first penetration depth.

3. The method according to claim 2, wherein the second indent is superimposed on the first indent.

4. The method according to claim 1, wherein the contact surface of the indenter lies on a sphere having a radius, R.

5. The method according to claim 4, wherein the first penetration depth is about 10% of R.

6. The method according to claim 4, wherein the second penetration depth is in the range from 15% to 20% of R.

7. The method according to claim 1, wherein the steps of obtaining the preliminary and more accurate measurements of the characteristic of the material are performed by numerically modelling the penetration of the indenter into the sample.

8. The method according to claim 1, wherein the characteristic of the material is a stress-strain curve.

9. The method according to claim 1, wherein the preliminary measurement of the characteristic of the material provides an indication of a work hardening rate of the material, and the determination that the second indent is required is made when the work hardening rate exceeds a predetermined level.

10. An apparatus for performing indentation plastometry, the apparatus including:
an indenter having a contact surface of a predetermined shape and size;
a testing machine configured to: apply a load to press the contact surface of the indenter into a sample of a material to form a first indent therein, the first indent having a first penetration depth, and measure a first indent profile of the first indent; and
a computer programmed to:
obtain a preliminary measurement of a characteristic of the material on the basis of: the first indent profile, and the applied load to form the first indent; and
based on the obtained preliminary measurement of the characteristic, determine whether a second indent having a different, second penetration depth is required to obtain a more accurate measurement of the characteristic of the material, and when the second indent is required, determine a value for the second penetration depth;
wherein:
the testing machine is further configured to: apply a load to press the contact surface of the indenter into the sample to form the second indent therein, the second indent having the second penetration depth, and measure a second indent profile of the second indent; and
the computer is further programmed to: obtain the more accurate measurement of the characteristic of the material on the basis of the second indent profile, and the applied load to form the second indent.

11. A computer program comprising code which, when the code is executed on a computer:
obtains a preliminary measurement of a characteristic of a material on the basis of results of a first indentation plastometry test in which: a first indent having a first penetration depth is formed within a sample of a material by applying a load to press a contact surface of an indenter into the sample, the contact surface having a predetermined shape and size, and the results of the first indentation plastometry test being the applied load to form the first indent, and a measured profile of the first indent;
on the basis of the obtained preliminary measurement of the characteristic of the material, determines whether a second indent having a different, second penetration depth is required to obtain a more accurate measurement of the characteristic of the material, and when the second indent is required, determines a value for the second penetration depth;
obtains the more accurate measurement of the characteristic of a material on the basis of results of a second indentation plastometry test in which: a second indent having the second penetration depth is formed within the sample of a material by applying a load to press the contact surface of an indenter into the sample, the results of the second indentation plastometry test being the applied load to form the second indent, and a measured profile of the second indent.

12. A computer readable medium storing the computer program according to claim 11.

13. A computer programmed to execute the computer program according to claim 11.
